(19) United States
(12) Patent Application Publication
(10) Pub. No.: US 2008/0235104 A1
(43) Pub. Date: Sep. 25, 2008

(54) System and method to promote electronic assets

(75) Inventors: Lee Chow, Naperville, IL (US); David Piepenbrink, Chicago, IL (US); Stephen Rys, Austin, TX (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/726,381

(22) Filed: Mar. 21, 2007

(51) Int. Cl. G06Q 30/00

(52) U.S. Cl. 705/26; 705/40; 705/59

(57) ABSTRACT

A system and method of promoting electronic assets is provided. The method may include promoting a plurality of heterogeneous digital assets via a common electronic system. Each of the digital assets may have one of a plurality of asset types. The common electronic system may be accessible via a plurality of different types of access points. The different types of access points may include a wireless access point and an interactive television access point.

### FIELD OF THE DISCLOSURE

The present disclosure is generally related to systems and methods to promote electronic assets.

### BACKGROUND

Many electronic devices utilize electronic assets, such as digital files including video, audio or data content, to provide services for users. For example, mobile telephones may utilize digital files including audio content, such as ringtone files, to notify users of incoming calls. Televisions may utilize digital files including video content, such as pay-per view content, video on demand content, or television content, to provide a video display. Computers may utilize digital files including video, audio, or data content to provide a variety of services for users. Finding or acquiring desired assets may be time consuming or inconvenient for users. Hence, there is need for an improved system and method to promote electronic assets.

### BRIEF DESCRIPTION OF THE DRAWINGS

FIG. 1 is a block diagram of a first particular embodiment of a system to promote electronic assets;

FIG. 2 is a block diagram of a second particular embodiment of a system to promote electronic assets;

FIG. 3 is a ladder diagram of a first particular embodiment of a method of promoting electronic assets;

FIG. 4 is a ladder diagram of a second particular embodiment of a method of promoting electronic assets;

FIG. 5 is a flow diagram of a first particular embodiment of a method of promoting electronic assets;

FIG. 6 is a flow diagram of a second particular embodiment of a method of promoting electronic assets;

FIG. 7 is a flow diagram of a third particular embodiment of a method of promoting electronic assets; and

FIG. 8 is a block diagram of an illustrative embodiment of a computer system.

### DETAILED DESCRIPTION OF THE DRAWINGS

In a particular embodiment, a system to promote electronic assets may include a content manager to identify a plurality of different electronic assets available for purchase. A first electronic asset may have a first asset type and a second electronic asset may have a second asset type. In an illustrative embodiment, the first and second asset types are different. The system may also include an interface to send data related to the plurality of electronic assets from the content manager via a distributed computer network. In an illustrative embodiment, the first and second electronic assets may be related. In an illustrative embodiment, the first asset type may include video on demand content.

In a particular embodiment, a method of promoting electronic assets may include promoting a plurality of heterogeneous digital assets via a common electronic system. In an illustrative embodiment, each of the digital assets may have one of a plurality of asset types. The common electronic system may be accessible via a plurality of different types of access points. The different types of access points may include a wireless access point and an interactive television access point.

In a particular embodiment, a computer readable medium may include computer readable instructions. The computer readable instructions may be executable by a computing system to identify a plurality of heterogeneous digital assets. Each digital asset has one of a plurality of asset types. In an illustrative embodiment, the heterogeneous digital assets may be related. The instructions may also be executable to cross-promote two or more of the heterogeneous digital assets via a plurality of different types of access points.

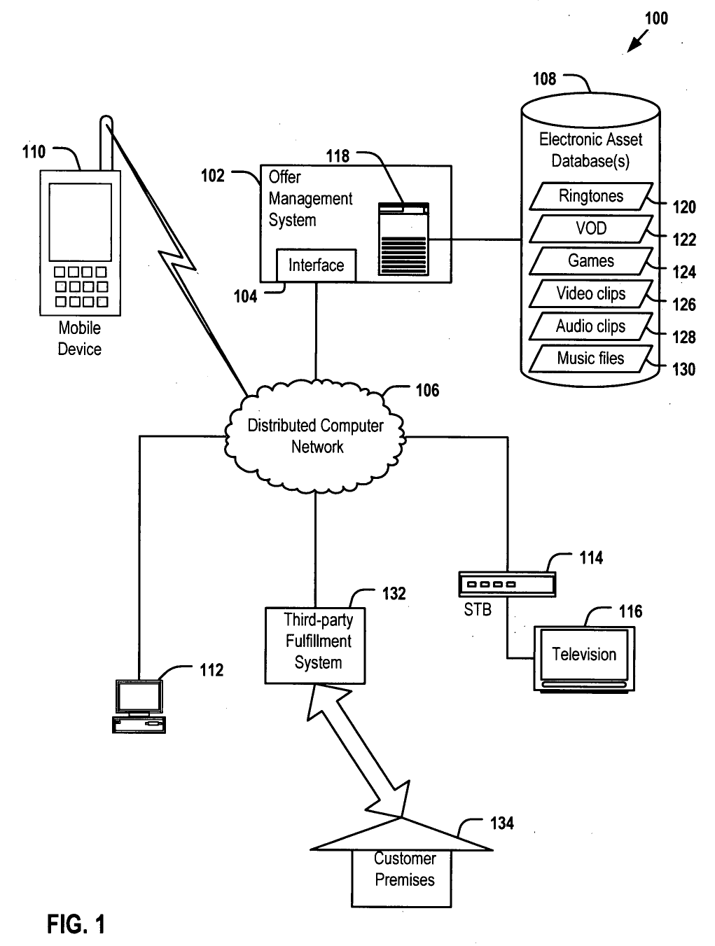

FIG. 1 is a block diagram of a first particular embodiment of a system to promote electronic assets, generally designated 100. The system 100 includes a distributed network 106 that facilitates communication between an offer management system 102 and one or more user devices, such as a set-top box device 114 coupled to one or more display devices 116; a computing device 112; and a mobile device 110. The offer management system 102 includes an interface 104 and a content and management fulfillment module 118. The user devices 110, 112, 114 can access a plurality of electronic assets in one or more electronic asset databases 108 by communicating with the offer management system 102 via the distributed computer network 106.

The electronic asset database(s) 108 may include a plurality of different electronic assets that are available for purchase. For,example, the electronic assets may include ringtones 120, video on demand (VOD) content 122, games 124, video clips 126, audio clips 128, music files 130, other electronic assets, or any combination thereof. In a particular embodiment, one or more of the electronic assets may be embodied in a physical storage medium, such as a digital video disk (DVD), a compact disk (CD), a hard disk, a flash memory, another physical storage medium, or any combination thereof. In a particular embodiment, the electronic asset database(s) 108 may include at least two different types of assets. For example, the electronic asset database(s) 108 may include a first asset having a first asset type, such as a ringtone 120, and a second asset having a second asset type, such as VOD content 122. In a particular embodiment, the two or more assets having different asset types may be related. For example, two or more of the electronic assets having different asset types may be related to one another in that they include related content, e.g., content based on or derived from a common source, such as a book, movie, song, game, etc. To illustrate, the ringtone 120 may include audio content related to a movie provided by the VOD content 122. That is, the VOD content 122 may include a movie with a particular song as part of its sound track, and the ringtone 120 may include or be derived from the particular song. Similarly, any combination of the electronic assets 120-130 may be related.

In a particular embodiment, the a content management and fulfillment module 118 can communicate with the electronic asset database(s) 108 to gather information about the electronic assets 120-130 and to make the electronic assets available to the user devices 110, 112, 114 for purchase or consumption. In an illustrative embodiment, the content management and fulfillment module 118 may retrieve metadata describing the available electronic assets and provide the metadata to the offer management system 102. The offer management system 102 may use the metadata to generate a storefront display that offers the one or more electronic assets for purchase. The content management and fulfillment module 118 may also facilitate sending content files including content of at least one of the electronic assets to the user devices 110, 112, 114 when an asset is purchased. For example, the content management and fulfillment module 118 may send a data file including the content of a purchased electronic asset via the distributed computer network 106 to one or more of the user devices 110, 112, 114. In another example, the content management and fulfillment module 118 may provide data to a device associated with an electronic asset, such as a third-party fulfillment system 132 or other fulfillment module to authorize transmission of the data file including the content of the purchased asset to one or more of the user devices 110, 112, 114. The third-party fulfillment system 132 may provide the electronic asset to one or more of the user devices 110, 112, 114 via the distributed computer network 106. In a particular embodiment where the electronic asset is embodied in a physical storage medium, the third-party fulfillment system 132 may send the electronic asset to a customer premises by physical delivery of the storage medium, for example, by mail or currier.

The offer management system 102 may provide the storefront display via the distributed computer network 106 to the user devices 110, 112, 114. The storefront display may include information about one or more of the electronic assets and make the electronic assets available for purchase. The offer management system 102 may provide the storefront display in a manner that is accessible by a variety of different user devices. In an illustrative embodiment, the distributed computer network 106 may include an Internet Protocol Television (IPTV) network, and the storefront display may be provided to the set-top box device 114 via a particular channel of the IPTV system or a web page accessible from a universal graphical user interface provided to the display device 116. In another illustrative embodiment, the distributed computer network 106 may include a wide area network, such at the Internet, and the storefront display may be provided to the computing device 112 via one or more web pages. In another illustrative embodiment, the distributed computer network 106 may include a wireless wide are network, such as a cellular telephone network, and the storefront display may be provided to the mobile device via one or more wireless messages, e.g., via a wireless access protocol (WAP), a wireless short message service (SMS) message, or a wireless multimedia message service (MMS) message.

In a particular embodiment, the system 100 may identify a plurality of heterogeneous digital assets, that is, assets of different asset types. Two or more of the heterogeneous digital assets may be related to one another. The offer management system 102 may be used to cross-promote two or more of the heterogeneous digital assets via a plurality of different types of access points to user devices 110, 112, 114. In an illustrative embodiment, cross-promotion of digital assets may include sending a solicitation message based on the user interest in the particular asset. For example, after determining user interest in a first digital asset, a solicitation may be sent to a first user access point to promote a second digital asset that is related to the first digital asset. Thus, the user may demonstrate interest in a first digital asset via a first user device and the offer management system 102 may send a solicitation to first user device, or to a second user device associated with the user. The solicitation may promote a second digital asset. To illustrate, the user may purchase VOD content, such as a movie, via the set-top box device 114. The offer management system 102 may send a solicitation promoting a second digital asset, such as a ringtone, associated with the first digital asset. The solicitation may be sent to the set-top box device 114, or the solicitation may be sent to a mobile device 110 or computing device 112 associated with the user.

In a particular embodiment, one or more of the electronic assets may be embodied in a physical storage medium, such as a DVD. I

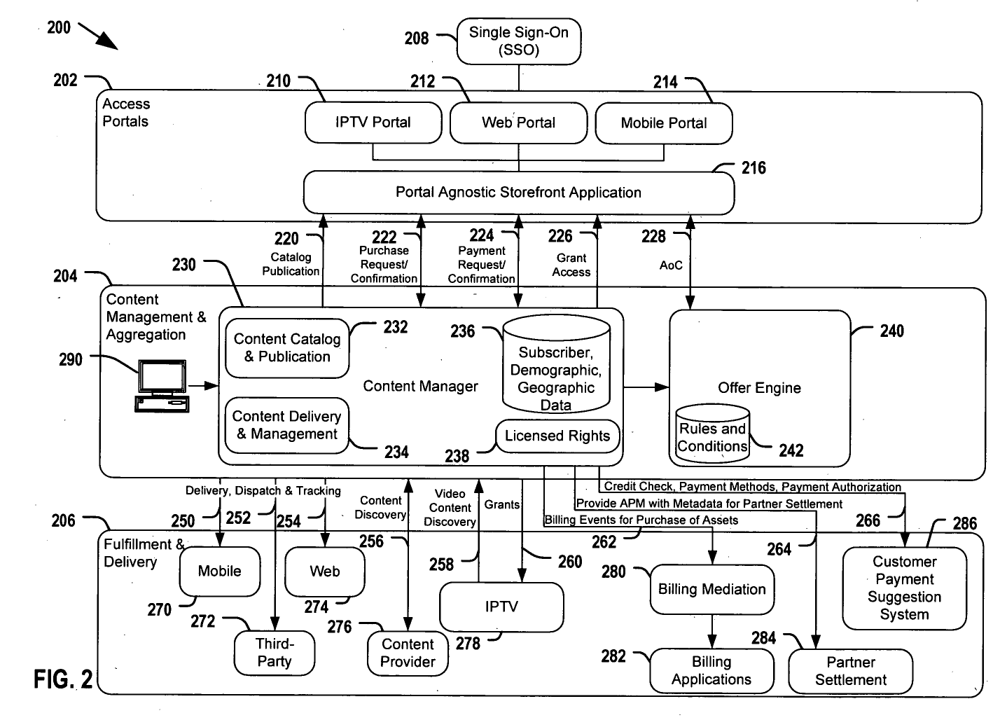

FIG. 2 is a block diagram of a second particular embodiment of a system to promote electronic assets, generally designated 200. The system 200 includes a single sign on interface 208 to communicate with one or more of a plurality of access points at an access portal module 202. The access points may include representative access points, such as an IPTV portal 210, a web portal 212, and a mobile device portal 214. The access portal module 202 also includes a portal agnostic storefront application 216. The portal agnostic storefront application 216 may send data related to a storefront display via the various access portals 210, 212, 214 to a user device that is signed on via the single sign on interface 208

The system 200 also includes a content management and aggregation module 204 having a content manager 230, an offer engine 240 and an administration device 290. The administration device 290 may communicate with the content management and aggregation module 204, the fulfillment and delivery module 206, and the access portal module 202 to allow administrative configuration of each module. For example, the administrative device 290 may be used to establish offer management rules stored at a rules and conditions database 242. In another example, the administrative device 290 may be used to configure a storefront display provided via the access portal module 202. In another example, the administrative device 290 may be used to configure a fulfillment module or transaction module of the fulfillment and delivery module 206.

In a particular embodiment, the content manager 230 includes a content catalog and publication module 232. The content catalog and publication module 232 may identify assets that are available to be offered for sale. For example, the content delivery and management module 234 may query content providers, such as the content provider 276, to identify assets that are available for purchase. The catalog and publication module 232 may process data received from the content providers 276 to identify metadata related to available assets, such as a description of the content of an asset, a format of the asset, a type of the asset, a cost of the asset, other information about the asset, or any combination thereof. The catalog and publication and module 232 may provide a catalog publication output 220 to the portal agnostic storefront application 216 identifying the available assets. The catalog and publication and module 232 may also provide information identifying the available assets to the offer engine 240 to allow offer rules related to the assets to be configured.

In a particular embodiment, the content manager 230 may also include a content delivery and management module 234. The content delivery and management module 234 may manage delivery of purchased assets to user devices. For example, the content delivery and management module 234 may receive payment information for the purchase of an asset via the portal agnostic storefront application 216. The content delivery and management module 234 may send an access grant message to a content provider after payment for an asset has been received and approved. The grant message may authorize the content provider to send the content of the purchased asset to the purchasing user device or another user device.

In a particular embodiment, the content manager 230 may also include a license rights module 238. The license rights module 238 may implement rules to ensure the license rights associated with digital assets are complied with. For example, the license rights module 238 may ensure that royalties associated with digital assets are paid. In another example, the license rights module 238 may determine an amount owed to a content provider or third party resulting from the purchase of a digital asset.

In a particular embodiment, the content manager 230 may also include a subscriber database 236. The subscriber database 236 may include subscriber data, such as demographic information and geographic information. The subscriber database may be utilized to establish promotional offers, to identify subscribers to which promotional offers should be made, to implement offer rules, and so forth. For example, the offer engine 240 may access the subscriber database 236 in order to determine whether a particular offer applies to a particular subscriber based on the subscriber data.

In a particular embodiment, the fulfillment and delivery module 206 may include a variety of fulfillment modules including a mobile module 270, a third party content module 272, a web module 274, a dedicated content provider module 276 and an Internet Protocol Television (IPTV) module 278. The fulfillment modules 270, 272, 274, 276 and 278 provide data identifying assets available for purchase to the content manager 230. In a particular embodiment, the fulfillment modules 270, 272, 274, 276 and 278 may also send data including the content of a purchased asset to a user device.

In a particular embodiment, the fulfillment and delivery module 206 may include one or more transaction application modules, such as a billing mediation module 280, a billing applications module 282, a partner settlement module 284, and customer payment suggestion module 286. The billing mediation module 280 may receive data related to the purchase of assets, e.g., billing events data, from the content manager 230 and may determine a charge for the purchase based on the data. The billing mediation module 280 may pass data related to the purchase to the billing applications module 282. The billing applications module 282 may prepare a bill to charge a subscriber for the purchase of an asset. For example, the billing application module 282 may add the charge to a unified subscriber bill for communication services, such as wireless telephone service, telephone service, television service (e.g., IPTV service), Internet access service, other communication services, or any combination thereof.

In a particular embodiment, the partner settlement module 284 may receive information associated with the purchase of an asset from the content manager 230. The partner settlement module 284 may process the purchase information to determine an amount owed to another party, such as a content provider, license rights holder, fulfillment agent, or other party. As a result of the purchase. The partner settlement module 284 may execute payment of the owed amount or pass information related to the owed amount to a payment system.

In a particular embodiment, the customer payment suggestion module 286 may also receive data from the content manager 230 related to purchase an asset. The purchase information may include a purchase price and information about the subscriber. The customer payment suggestion module 286 may determine available payment options for the subscriber, such as a charge to the subscriber's account (e.g., a communication services account), payment by credit card, payment by electronic funds transfer, other payment options, or any combination thereof.

The content management and aggregation module 204 may communicate with the fulfillment and delivery module 206 via a plurality of communication links. Representative examples of the communication links may include delivery, dispatch and tracking communication links 250, 252, 254, content discovery communication link 256, video content discovery link 258, IPTV access grant communication link 260. In addition, the content management and aggregation module 204 may communicate with the transaction application modules of the fulfillment and delivery module 206 via a billing event communication link 262, a partner settlement communication link 264 and credit check and payment authorization communication link 266.

The content manager 230 may communicate with the portal agnostic storefront application 216 via a plurality of communication links 220-228. Representative examples of the communication links may include a catalog publication communication link 220 to provide information about available assets, purchase request/confirmation communication link 222 to communicate purchase and purchase confirmation information, a grant access communication link 226 to communicate access grants, and a payment request confirmation communication link 224 to communicate payment request and confirmation information. In addition, the offer engine 240 may communicate with the portal agnostic storefront application 216, for example, via an advice of change (AOC) communication link 228.

During operation of a particular embodiment, the content manager 230 prepares a catalog of assets available for purchase and provides the catalog of assets to the administration device 290 for configuration of offer rules and conditions related to the assets. The offer engine 240 implements the offer rules and conditions to promote the assets in the catalog via a storefront display sent to user devices via the portal agnostic storefront application 216. The content manager 230 receives requests for purchase of such assets via the portal agnostic application 216. The offer engine 240 provides an advice of charge (AoC) to the subscriber associated with the purchase via the portal agnostic storefront application 216. If the subscriber approves the charge, the content manager 230 sends payment information to the transaction application modules 280, 282, 284, 286 and communicates with the fulfillment and delivery module 206 in order to fulfill the purchase.

In a particular embodiment, after purchase of the asset, the portal agnostic storefront application 216 may provide the content of the electronic asset via a suitable interface based on the asset type. For example, IPTV related asset may be provided via the IPTV portal 210, an internet asset may be available via the web portal 212, and a mobile asset may be available via the mobile portal 214. Additionally, the content manager 230 may interact with the fulfillment and delivery module 206 to provide billing information necessary to billing the subscriber for the asset purchase and to pay content providers or others third parties for the transaction.

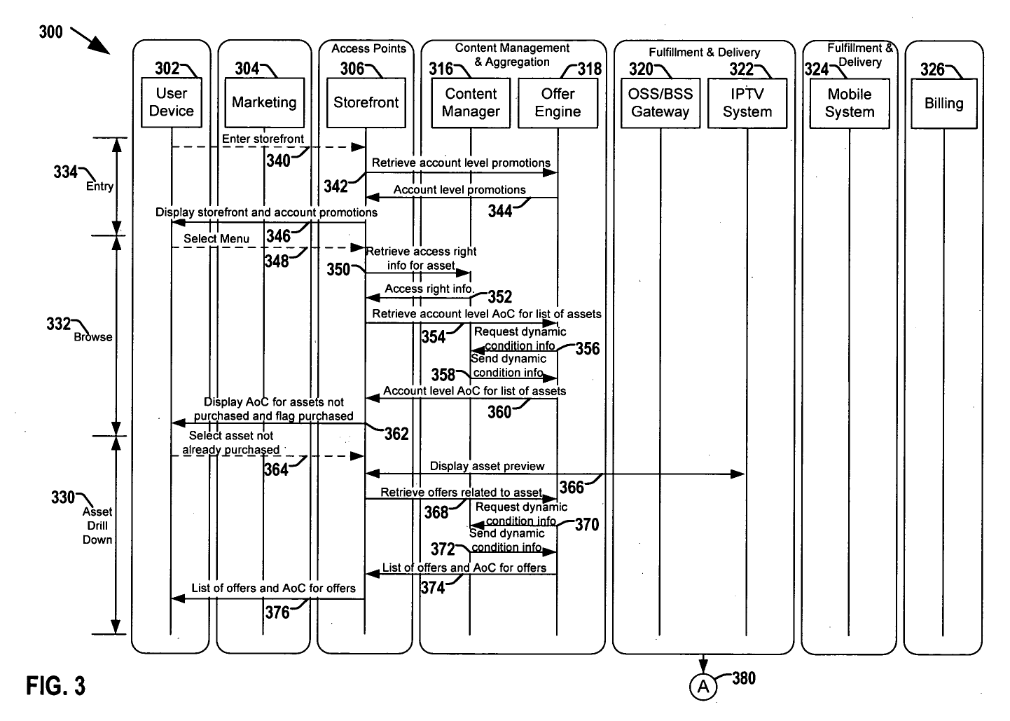

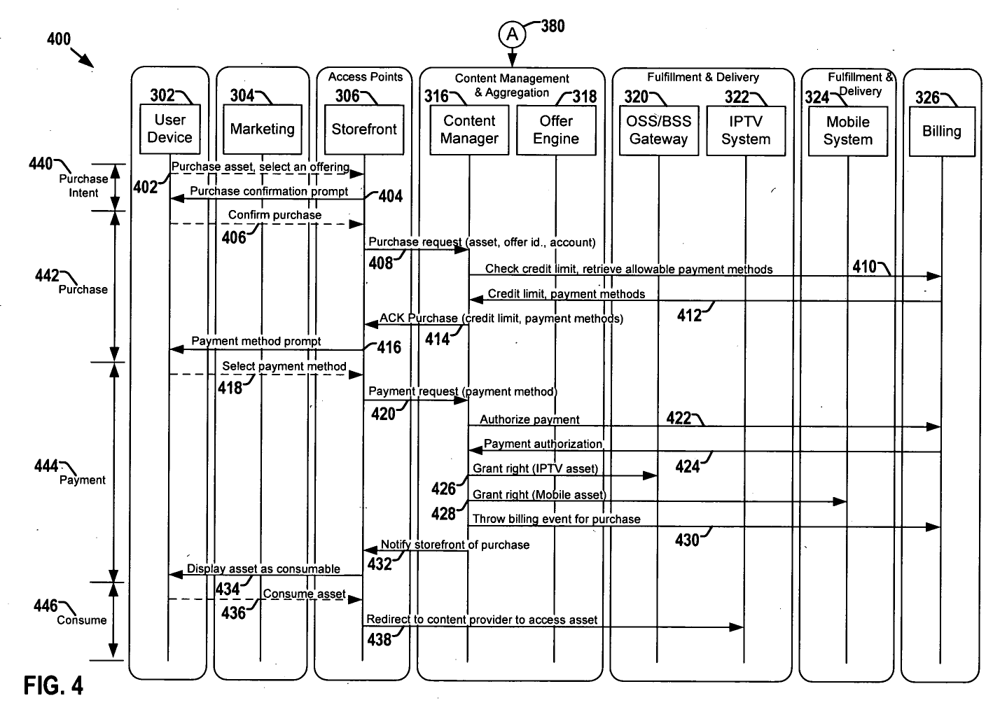

FIGS. 3 and 4 include ladder diagrams that illustrate examples of interactions between various modules to implement particular embodiments of a method of promoting electronic assets. In particular, the ladder diagrams illustrate interactions between a user device 302, a marketing module 304, a storefront module 306, a content manager 316, an offer engine 318, an operation systems and support (OSS) billing systems and support (BSS) gateway 320, an Internet Protocol Television (IPTV) system 322, a mobile module 324, and a billing module 326.

Referring to FIG. 3, a ladder diagram of a first particular embodiment of a method of promoting electronic assets is shown and is generally designated 300. The method 300 includes various stages including an entry stage 334, a browse stage 332, and an asset drill down stage 330.

In connection with the entry stage 334, a message 340 may be sent from the user device 302 to the storefront module 306. The message 340 may include a request to enter the storefront, e.g., to access data related to a storefront display. The storefront module 306 may include a portal agnostic application adapted to communicate with a variety of user devices, such as the user device 302. The storefront module 306 sends a message 342 to the offer engine 318 to request account level promotions. In an illustrative embodiment, account level promotions may include promotions offered to a particular user based on subscriber data associated with the user. For example, an account level promotion may be offered to a user based on the user's purchase history, location or other subscriber data. The offer engine 318 responds to the storefront module 306 with a message 344 including account level promotions information. The storefront module 306 sends a message 346 to the user device 302 including the storefront data and the account level promotions.

In connection with the browse stage 332, the user device 302 may display a user interface based on the storefront data and the account level promotions. In an illustrative embodiment, the user interface may include one or more selectable menus associated with particular assets. If the user selects a menu, the user device 302 may send a message 348 indicating the selection to the storefront module 306. The storefront module 306 may send a message 350 to the content manager 316 to retrieve access right information regarding the selection. The content manager 316 may respond with a message 352 including the access right information. In a particular embodiment, a user may have access rights to an asset indicating whether the asset has been purchased, is available for purchase, or has already been viewed.

The storefront module 306 may also send a message 354 to the offer engine 318 to retrieve advice of charge (AoC) information (e.g., purchase price information) related to assets associated with the menu. The offer engine 318 may send a message 356 to the content manager 316 requesting dynamic condition information, and the content manager 316 may respond with a message 358 including the dynamic condition information. The offer engine 318 may determine the advice of charge for the account of each asset identified by storefront module 306 in the message 354 based on the dynamic condition information. If no offers apply to a particular asset, the offer engine 318 may not return anything for the particular asset. If multiple offers apply to a particular asset, the offer engine 318 may return one AoC, but may also indicate that other offers also apply. In a particular embodiment, if multiple offers apply to a particular asset, the offer engine 318 may return the AoC having the lowest price. The offer engine 318 may send a message back to the storefront module 306 with the account level AoC for the list of assets. The storefront module 306 may send a message 362 to the user device 302 including a list of assets that are available for purchase and an AoC related to each available asset. In a particular embodiment, the storefront module 306 may only list an advice of charge for assets that are available for purchase. The message 362 from the storefront module 306 may also include information identifying assets that have already been purchased.

In connection with the asset drill down stage 330, a user may select an asset that has not already been purchased, and the user device 302 may send a message 364 indicating the selection to the storefront module 306. The storefront module 306 may access a preview of the selected asset from a fulfillment and delivery module. For example, for a video on demand asset, the storefront module 306 may access the preview from the IPTV system 322 via a message 366. The storefront module 306 may also send a message 368 to the offer engine 318 to retrieve offers related to the selected asset. The offer engine 318 may determine the dynamic condition from the content manager 316 via messages 370 and 372. The offer engine 318 may provide a list of offers relate to the asset and AoC for each offer to the storefront module 306 via a message 374. The storefront module 306 may provide the list of offers related to the asset and the AoC for each such asset to the user device 302 via a message 376. If, after the asset drill down stage 330, the user continues with the purchase of the selected asset, the method 300 may proceed, at 380, to the method 400 depicted in FIG. 4.

Referring to FIG. 4, a ladder diagram of a second particular embodiment of a method of promoting electronic assets is shown and is generally designated 400. The method 400 may continue at 380 from the method 300 depicted in FIG. 3. The method 400 includes a purchase intent stage 440, a purchase stage 442, a payment stage 444, and a consume stage 446.

In connection with the purchase intent stage 440, a user may indicate an intent to purchase a selected asset, and the user device 302 may send a message 402 identifying the selected asset and offer to the storefront module 306. The storefront module 306 may request confirmation of the intent to purchase the asset via message 404.

In connection with the purchase stage 442, the user device 302 may send a message 406 to the storefront module 306 confirming the purchase. In response to the confirmation message 406, the storefront module 306 sends a purchase request message 408 including an identification of the asset, the offer and the user account to the content manager 316.

The content manager 316 may send a message 410 to the billing module 326 to retrieve allowable payment methods for the purchase and to determine a credit limit associated with the account. The billing module 326 may respond with a message 412 indicating the credit limit and authorized payment methods. If the credit limit and payment methods allow the purchase, the content manager 316 may send a message 414 to the storefront module 306 acknowledging the purchase and identifying the allowable payment methods and credit limit. The storefront module 306 may send a message 416 to the user device 302 prompting the user for a payment method based on the allowable payment methods and credit limit.

In connection with the payment stage 444, the user may select a payment type and send a message 418 via the user device 302 indicating the selection to the storefront module 306. The storefront module 306 may send a message 420 including a payment request and indicating a payment method to the content manager 316. The content manage 316 may send a message 422 to the billing module 326 requesting authorization of the payment. The billing module 326 may respond with a message 424 authorizing the payment. The content manager 316 may send a message to a fulfillment module to grant rights to access the asset to the user device 302. For example, for a video on demand (VOD) asset, the content manager 316 may send a message 426 to an OSS/BSS gateway 320 associated with the IPTV system 322 to grant rights to the user device 302. In another example, for a mobile asset, the content manager 316 may send a message 428 to a mobile system 324 to grant rights to the user device 302. The content manager 316 may also send a message 430 indicating the occurrence of a billing event to the billing system 326. The content manager 316 may send a message 432 to the storefront module 306 indicating that the purchase is complete. The storefront module 306 may send a message to the user device 302 displaying the purchased asset as consumable, e.g., indicating that the asset has been purchased and is available to be consumed.

In connection with the consume stage 446, the user may send a message 436 via user device 302 to the storefront module 306 including a request to consume the asset. The storefront module 306 may send a message 438 redirecting the user device to a fulfillment module, such as the IPTV system 322 or mobile system 324.

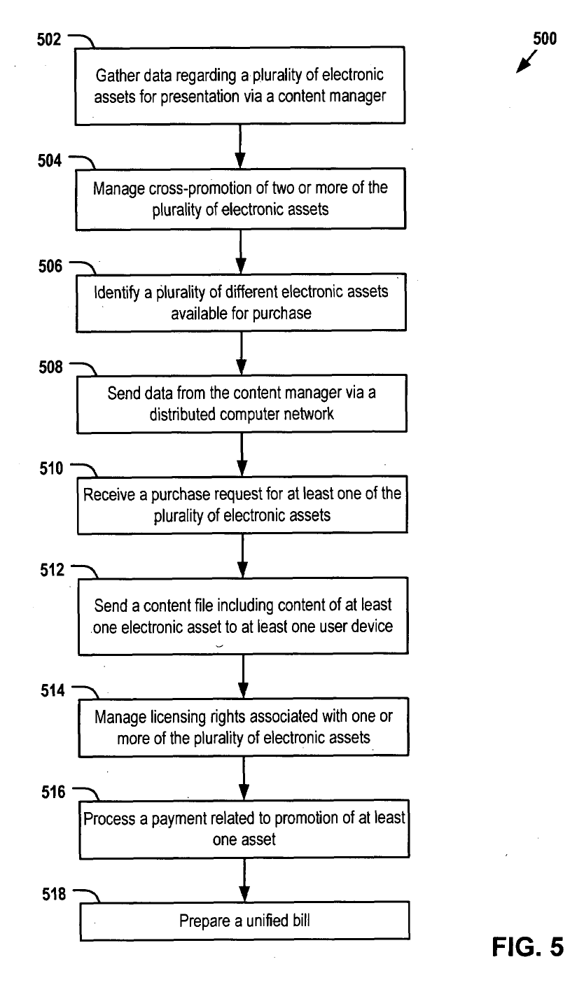

FIG. 5 is a flow chart of a first particular embodiment of a method of promoting electronic assets, generally designated 500. The method 500 includes, at 502, gathering data related to a plurality of electronic assets for presentation via a content manager. The method 500 further includes, at 504, managing cross-promotion of two or more electronic assets. In a particular embodiment, the cross-promotion of two or more electronic assets may be carried out by an offer engine based on a plurality of offer rules and conditions.

The method 500 may also include, at 506, identifying a plurality of different electronic assets available for purchase. In a particular embodiment, a first electronic asset of the plurality of electronic assets may have a first asset type and a second electronic asset may have a second asset type. Further, the first and second electronic assets may be related to one another. For example, the first asset type may be video on demand (VOD) content, and the second asset type may be a ringtone. The ringtone may include content associated with the VOD content. The plurality of different electronic assets may be identified, for example, by the content manager via a storefront display. The method 500 also includes, at 508, sending data related to the plurality of electronic assets from the content manager via a distributed computer network. For example, the content manager may send the data as a storefront display to one or more user devices via one or more access point portals.

In a particular embodiment, the method 500 includes, at 510, receiving a purchase request for at least one of the plurality of electronic assets via the distributed computer network. For example, the content manager may receive the purchase request from a user device via the storefront display. The method 500 may also include, at 512, sending a content file including content of at least one of the plurality of electronic assets via the distributed computer network to at least one user device. For example, the content manager may process the purchase order and authorize a fulfillment module to send the content file to the user device. In a particular embodiment, the user device may include a mobile device, a set-top box, a television, a computing device, another user device capable of accessing and utilizing an electronic asset, or any combination thereof.

In a particular embodiment, the method 500 may include, at 514, managing licensing rights associated with one or more of the plurality of electronic assets, as shown at 516. For example, a license module may manage the licensing rights to comply with licensing rights associated with the electronic assets. The method 500 may include, at 516, processing a payment related to promotion of at least one of the plurality of electronic assets. In a particular embodiment, a settlement system may process the payment related to the promotion of the at least one asset. In an illustrative embodiment, processing the payment may include receiving a payment as compensation for promoting the asset or pay compensation to a content provider as a result of sale of a promoted asset. The method 500 may include, at 518, preparing a unified bill related to transactions associated with one or more of the plurality of electronic assets. In a particular embodiment, a billing system may prepare the unified bill. The unified bill may also include charges related to communication services, such as telephone communication service, wireless telephone communication service, Internet service, television service, other communication services, or any combination thereof.

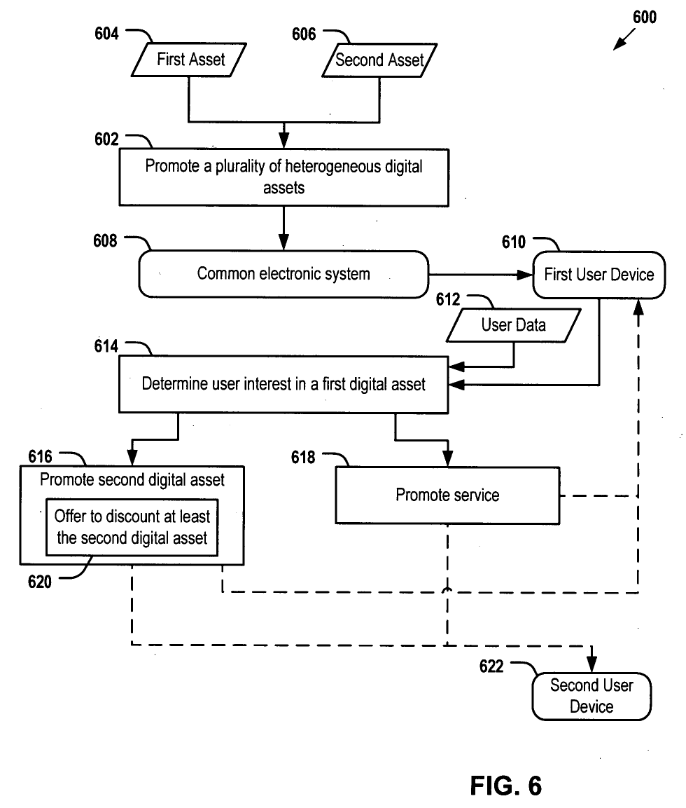

FIG. 6 is a diagram of a second particular embodiment of a method of promoting electronic assets, generally designated 600. The method 600 includes, at 602, promoting, a plurality of heterogeneous digital assets, such as a first asset 604 and a second asset 606, via a common electronic system 608. Each of the assets 604, 606 has one of a plurality of available asset types. In addition, common electronic system 608 may be accessible to user devices, such as a first user device 610 and a second user device 622, via a plurality of different access points. In a particular embodiment, the plurality of different access points may include different types of access points, such as a wireless communication access point, an interactive television access point, or an Internet access point. The method 600 may also include, at 614, determining user interest in the first digital asset 604. In a particular embodiment, user interest in the first digital asset 604 may be determined based on user data 612 which may indicate a user selection of the asset, a user purchase of the asset, or historical, demographic or geographic data related to the user. For example, user interest in the first digital asset 604 may be determined based on the user's historical purchases, the user's location, other information associated with the user, or any combination thereof.

In a particular embodiment, after determining user interest in the first digital asset 604, the method 600 may include, at 616, promoting the second digital asset 606 or, at 618, promoting a service. In an illustrative embodiment, promoting the second digital asset 606 or service may include sending a solicitation message to the user at a user device. For example, the solicitation message may be sent to the user device via which user interest in the first digital asset 604 was determined, such as the first user device 610, or to a user device associated with the asset type of the second asset 606, such as the second user device 622. In another example, the solicitation message may be sent to a user device via which user interest in the first digital asset 604 was determined, such as the first user device 610, or to a user device associated with the offered service, such as the second user device 622. In an illustrative embodiment, promoting the second digital asset 606 may include, at 620, offering to discount at least the second digital asset. To illustrate, the first digital asset may be a ringtone. After determining user interest in the ringtone, the method 600 may offer a user the opportunity to receive the ringtone for free if the user subscribes to an offered service, such as a communication service.

In a particular embodiment, the first user device 610, the second user device 622, or both may include a television device or a set top box device in communication with an offer management system via an interactive television access portal. In another particular embodiment, the first user device 610, the second user device 622, or both may include a mobile device in communication with an offer management system via a mobile device portal. In another particular embodiment, the first user device 610, the second user device 622, or both may include a computing device in communication with an offer management system via a web portal.

In a particular embodiment, two or more of the plurality of heterogeneous digital assets may be related to each other. For example, the first digital asset 604 and the second digital asset 606 may include related content, such as content based on or derived from a common source. Additionally, in a particular embodiment, the first digital asset 604 may have a first asset type and the second digital asset 606 may have a second access asset type. For example, the first digital asset 604 may include an audio clip and the second digital asset 606 may include a video clip. In another example, the first digital asset 604 may include an audio clip associated with a movie and the second digital asset 606 may include content of the movie. In another example, the first digital asset may include a movie and the second digital asset may include an audio clip that is associated with the movie, such as a song, sound effect, or excerpt of dialog.

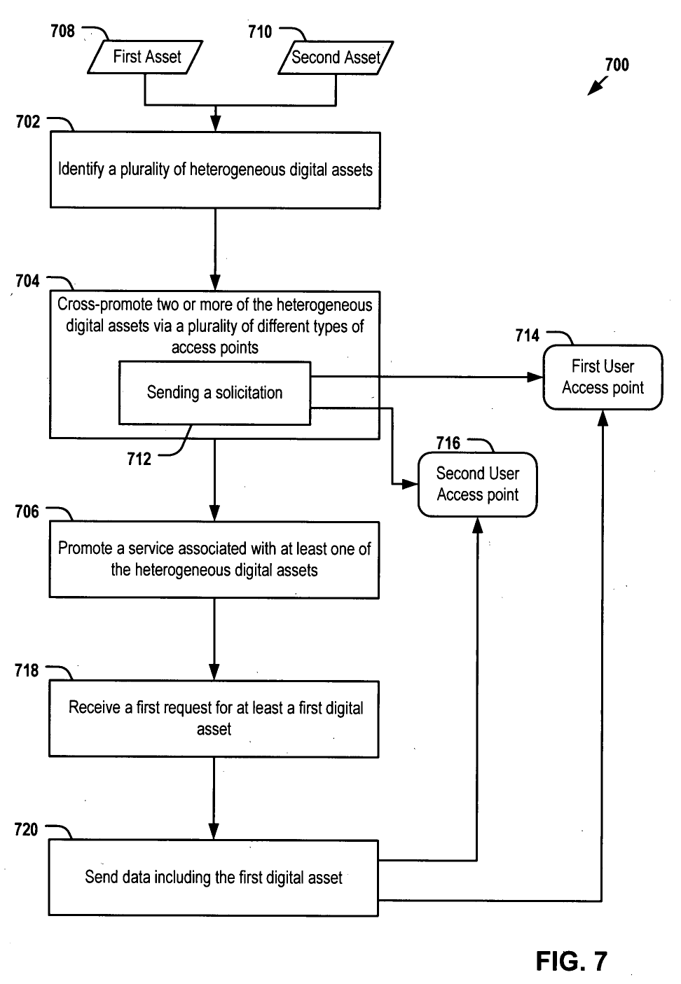

FIG. 7 is a diagram of a third particular embodiment of a method of promoting electronic assets, generally designated 700. The method 700 may be executable by a processor or distributed computing system based on software instructions to promote a plurality of heterogeneous digital assets. In a particular illustrative embodiment, at least one of the heterogeneous digital assets may include video on demand content. In another particular illustrative embodiment, at least one of the heterogeneous digital assets may include a ringtone.

The method 700 includes, at 702, identifying a plurality of heterogeneous digital assets, such as first asset 708 and second asset 710. The method 700 further includes, at 704, cross-promoting two or more of the heterogeneous digital assets via a plurality of different types of access points. In a particular embodiment, cross-promoting two or more heterogeneous digital assets may include, at 712, sending a solicitation to a first user access point 714 or to a second user access point 716. The solicitation may promote the second digital asset 710, which may be related to the first digital asset 708. The first digital asset 708 and the second digital asset 710 may have different asset types.

In a particular embodiment, the method includes, at 706, promoting a service associated with at least one of the heterogeneous digital assets. In a particular embodiment, the method 700 may also include, at 718, receiving a first request for at least the first digital asset 708 and, at 720, sending data including the first digital asset 708 to the first user access point 714 based at least partially on the first request.

In conjunction with the configuration of structure described herein, the systems and methods disclosed promote electronic assets. In a particular illustrative embodiment, a common electronic system may be used to promote a plurality of heterogeneous digital assets with different asset types. The common electronic system may be accessible via a plurality of different types of access points. For example, the access points may include a wireless access point and an interactive television access point.

In a particular embodiment, the storefront display, offer management system and fulfillment system described herein may provide a powerful vehicle to cross-promote and cross-sell heterogeneous assets (e.g., video assets, mobile assets, computing assets, and so forth) via a common unified storefront interface that is accessible via multiple types of access points. The system may allow for promotional offers to be created across heterogeneous asset types. For example, promotional offers may bundle different types of assets or services, or may promote assets based on user information such as geography, demographics, historical purchases, etc. Such systems may also enable increased commercial opportunities as the heterogeneous assets may be browsed through the unified storefront interface. The system may also support converged assets, i.e., assets that can be consumed via more than one user device. For example, video on demand assets that can be viewed via a television device, a mobile device, a computing device, or another user device. Thus, the system may allow for access to the unified storefront interface via a variety of user devices, to promote a variety of heterogeneous electronic assets that may be consumed via a variety of user devices. With this flexible system the heterogeneous assets may be cross-promoted, bundled, or otherwise cross-marketing to facilitate increased customer attraction and enhanced revenue opportunities for content providers and service providers. In addition, increased subscriber penetration may be achieved through such bundled promotions and cross-promotions. Further, through use of an integrated billing system, increased usability and convenience from a user prospective may be achieved.

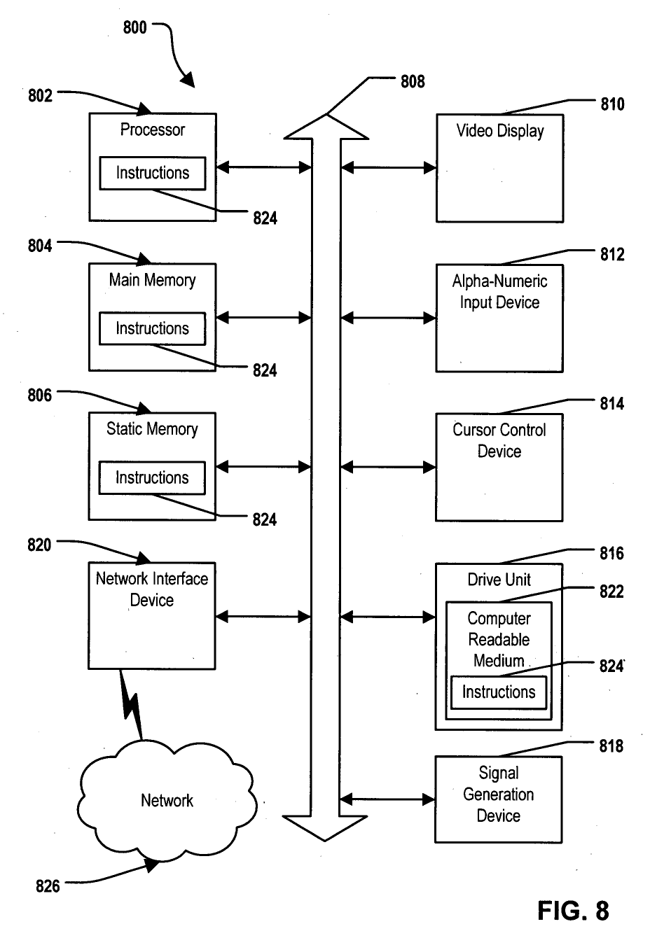

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices. In an illustrative embodiment, the computer system 800 may include any one or more of the user devices, offer management system devices, content management devices, databases, modules, or other devices depicted in and described with reference to FIGS. 1-7.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806, that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816,.a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a content manager to identify a plurality of different electronic assets available for purchase, wherein a first electronic asset has a first asset type and a second electronic asset has a second asset type, and wherein the first and second asset types are different; and
an interface to send data related to the plurality of electronic assets from the content manager via a distributed computer network;
wherein the first and second electronic assets are related; and
wherein the first asset type includes video on demand content.

2. The system of claim 1, wherein the second asset type includes a ringtone including an audio clip related to the video on demand content.

3. The system of claim 1, wherein the second asset type includes music content related to the video on demand content.

4. The system of claim 1, wherein the second asset type includes game content related to the video on demand content.

5. The system of claim 1, wherein the interface provides a storefront display via a channel of an Internet Protocol Television (IPTV) system.

6. The system of claim 1, wherein the content manager is further adapted to receive a purchase request for at least one of the plurality of electronic assets via the distributed computer network.

7. The system of claim 1, further comprising a fulfillment module to send a content file including content of at least one of the plurality of electronic assets via the distributed computer network to at least one user device.

8. The system of claim 1, wherein the distributed network comprises a wide-area wireless communication network.

9. The system of claim 1, further comprising a settlement system to process a payment related to promotion of at least one of the plurality of different electronic assets via the content manager.

10. The system of claim 1, wherein the content manager is further adapted to gather data regarding the plurality of electronic assets for presentation from one or more content providers.

11. The system of claim 1, further comprising an offer engine to manage cross-promotion of two or more of the plurality of electronic assets.

12. The system of claim 1, further comprising a license management system to manage licensing rights associated with one or more of the plurality of electronic assets.

13. The system of claim 1, further comprising a billing system to prepare a unified bill, wherein the unified bill includes at least one charge related to a transaction associated with one or more of the plurality of electronic assets and at least one charge related to providing communication services.

14. A method comprising:
promoting, via a common electronic system, a plurality of heterogeneous digital assets, each of such assets having one of a plurality of asset types, wherein the common electronic system is accessible via a plurality of different types of access points, and wherein the different types of access points include a wireless access point and an interactive television access point.

15. The method of claim 14, wherein the interactive television access point includes an Internet Protocol Television (IPTV) access point.

16. The method of claim 14, wherein the plurality of different types of access points include an Internet access point.

17. The method of claim 14, wherein two or more of the plurality of heterogeneous digital assets are related to each other.

18. The method of claim 14, further comprising determining user interest in a first digital asset and promoting a second digital asset.

19. The method of claim 18, wherein the first digital asset has a first asset type and the second digital asset has a second asset type, and wherein the first digital asset and the second digital asset are related.

20. The method of claim 18, wherein promoting the second digital asset comprises offering to discount at least the second digital asset.

21. The method of claim 14, further comprising determining user interest in a first digital asset and promoting a service.

22. The method of claim 14, wherein the first digital asset comprises an audio clip associated with a movie, and the second digital asset comprises the movie.

23. The method of claim 14, wherein the first digital asset comprises a movie, and the second digital asset comprises an audio clip associate with the movie.

24. A computer readable medium comprising computer readable instructions, wherein the computer readable instructions are executable by a computing system to:
identify a plurality of heterogeneous digital assets, each digital asset having one of a plurality of asset types, wherein the heterogeneous digital assets are related; and
cross-promote two or more of the heterogeneous digital assets via a plurality of different types of access points.

25. The computer readable medium of claim 24, wherein the instructions are further executable to receive a first request for at least a first digital asset, and send data including the first digital asset to a first user access point based at least partially on the first request.

26. The computer readable medium of claim 25, wherein cross-promoting two or more of the heterogeneous digital assets comprises sending a solicitation to a first user access point, the solicitation promoting a second digital asset related to the first digital asset, wherein the first digital asset and the second digital asset have different asset types.

27. The computer readable medium of claim 25, wherein cross-promoting two or more of the heterogeneous digital assets comprises sending a solicitation promoting a second digital asset related to the first digital asset to a second user access point.

28. The computer readable medium of claim 24, wherein the instructions are further executable to promote a service associated with at least one of the heterogeneous digital assets.

29. The computer readable medium of claim 24, wherein at least one of the heterogeneous digital assets comprises video on demand content.

30. The computer readable medium of claim 24, wherein at least one of the heterogeneous digital assets comprises a ringtone.
